(19) United States
(12) Patent Application Publication
(10) Pub. No.: US 2007/0255781 A1
(43) Pub. Date: Nov. 1, 2007

(54) Content driven process routing for integrated enterprise applications

(75) Inventors: John Yu-Hsien Li, Saratoga, CA (US); Lin Wang, Palo Alto, CA (US)

Correspondence Address: COURTNEY STANIFORD & GREGORY LLP, P.O. BOX 9686, SAN JOSE, CA, 95157, US

(73) Assignee: BayHub, Inc.

(21) Appl. No.: 11/411,412

(22) Filed: Apr. 26, 2006

(51) Int. Cl. G06F 15/16; G06F 15/173

(52) U.S. Cl. 709/201; 709/226

(57) ABSTRACT

In one embodiment, an application integration system receives business application information and generates certain business flow and state information for the application, users based on the shared business content within the system. The content driven routing process facilitates the routing of application processes and user communication on the basis of the business content. The content-based routing process establishes integration connections on demand among users and or applications based on the business content utilized by their respective applications. Content data is encapsulated within a content table that consists of a number of tags that describe various parameters related to the content, such as user profiles, application that use the content, and data types within the content, so that it can be properly routed within the hub and processed by the integrated applications. The routing process of the collaboration hub routes the content or task to the appropriate user in the system and provides the hooks to invoke the appropriate application or otherwise process the content.

### CROSS-REFERENCE TO RELATED APPLICATIONS

The current application is related to U.S. Patent Application entitled “Collaborative Hub System for Accessing and Managing Shared Business Content” filed on Apr. 25, 2006, and U.S. Patent Application entitled “Checkpoint Flow Processing System for On-Demand Integration of Distributed Applications” filed on Apr. 25, 2006.

### FIELD

Embodiments of the invention relate generally to computer applications, and more specifically, to a system for routing content data among silo applications to make them virtually integrated.

### BACKGROUND

The traditional deployment of enterprise applications is characterized by the implementation and use of separate application programs among different users or teams in the overall organization. For example, in a manufacturing organization, one team may use a CAD/CAM program to design and manage the production of a product, while other teams may use finance programs, inventory management programs, customer relationship management (CRM) programs, and so on to manage their respective aspects of the project. Typically, each application is treated as a separate program with its own set of users, input/output data, business rules, timelines, process flows, and so on. Throughout the entire project lifecycle, business content, in the form of documents, files, databases, contacts and the like is continually created and modified by the people and the processes within the system. However, it is usually the case that a common set of data or content is used by the different teams. The deployment of individual “silo applications” does not facilitate the sharing of common data and often results in little or no cross work team communications, as each user in each application is assigned a specific and unique role, and has little if any access to any other application or the business content of those applications. Because business content data is usually strongly protected by each individual application, little or no data synchronization or true sharing is typically possible. Normally the shared cross team business content information is controlled and managed by different groups of users and groups of silo applications. Thus, when a cross team member needs to synchronize the content or project status, he or she must often dump the shared business content to a flat file/spreadsheet from the application and email or fax it to the team members and partners in order to share this content. This manual and mesh-based communication method is error-prone, lacks integrity, virtually unmanageable, time consuming, and potentially very costly in the context of complicated enterprise projects.

The management of content, user communication, process interactions, and application rules is especially problematic in current deployed enterprise systems that involve several different teams all running disparate applications, yet require some degree of interactivity and access to common business content. This is largely due to the fact that content is usually stored in flat file structures and each team has its own application platform, deployment infrastructure, and defined user roles. As mentioned above, user interaction in this case often requires individual transmission of business content and manual transmission modes, such as fax/phone/e-mail outside of each user's application platform, and is thus an inefficient, insecure, and costly method of communication that results in a lack of synchronization, automation and unmanaged network of communications. Although enterprises can choose to implement the point-to-point integration of applications or users, such integration links typically result in a complicated mesh scheme where every application or user is connected to every other application or user. Moreover, such networks often contain a large number of useless or redundant links. This is because present systems do not tailor the actual communication and process routing based on the specifics of the business content and processes being used, and therefore, worst-case integration structures are put in place, resulting in complicated and expensive mesh schemes.

### BRIEF SUMMARY OF THE INVENTION

Embodiments of a system for providing a content-driven routing scheme among a number of different integrated applications and work teams in a distributed enterprise environment is described. Embodiments are directed to an application integration and collaboration hub platform that includes a content-driven routing process. In general, the application integration system receives business application information and generates certain business flow and state information for the application, users based on the shared content within the system. The content-driven routing process facilitates the routing of application processes and user communication on the basis of the business content.

The content-based routing process establishes on-demand integration connections among users and/or applications based on the business content utilized by their respective applications. Content data is encapsulated within a content table that consists of a number of tags that describe various parameters related to the content, such as user profiles, application that use the content, application profile, data details within the content, and the respective business rules and processes, so that it can be properly routed within a hub defined by the collaboration hub platform and processed by the integrated applications, and users in real time.

### BRIEF DESCRIPTION OF THE DRAWINGS

Embodiments of the present invention are illustrated by way of example and not limitation in the figures of the accompanying drawings, in which like references indicate similar elements and in which:

FIG. 1A is a block diagram of a computer network system that implements embodiments of a content driven routing process.

FIG. 1B illustrates an example of interactivity among a plurality of business applications and entities, according to an embodiment.

FIG. 1C illustrates the processing of business content in a content driven routing platform, according to an embodiment.

FIG. 1D is a table illustrating an example of an application message bus matrix, under an embodiment.

FIG. 2 illustrates the main execution modules of a content driven routing system, according to an embodiment.

FIG. 3 is a flowchart that illustrates a method of processing shared content in a content driven routing system, according to an embodiment.

FIG. 4 illustrates the tagging of business content with identifier hooks, under an embodiment.

FIG. 5 is a table illustrating a profile registry, under an embodiment.

FIG. 6 illustrates the creation of content-based transmission routes among users and integrated applications, according to an embodiment.

FIG. 7 illustrates the development of content-based routes from mesh-based network links, according to an embodiment.

### DETAILED DESCRIPTION

Embodiments of a system for providing a content-driven routing scheme among a number of different integrated applications and work teams in a distributed enterprise environment is described. In general, the term “distributed enterprise application environment” refers to cross team and cross company scenarios present in a large scale project involving different networked users. In the following description, numerous specific details are introduced to provide a thorough understanding of, and enabling description for, embodiments of the content driven routing process. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

Embodiments are directed to a content routing process for an application integration and collaboration hub platform, such as that described in concurrently filed and commonly owned U.S. patent applications entitled, “Collaborative Hub System for Accessing and Managing Shared Business Content” and “Checkpoint Flow Processing System for On-Demand Integration of Distributed Applications,” which are both hereby incorporated by reference in their entirety.

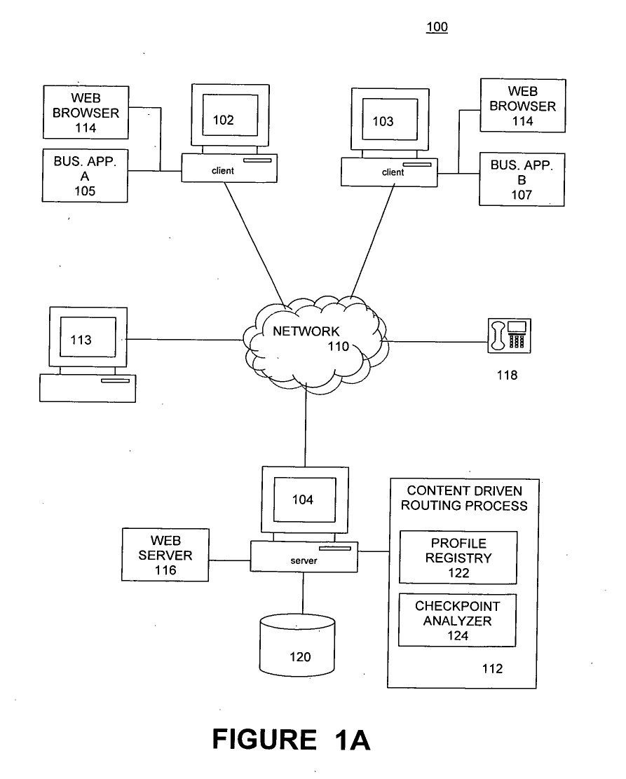

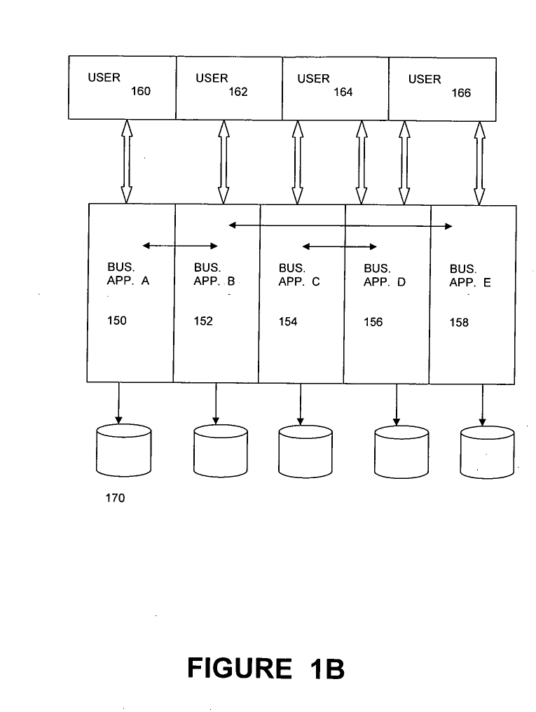

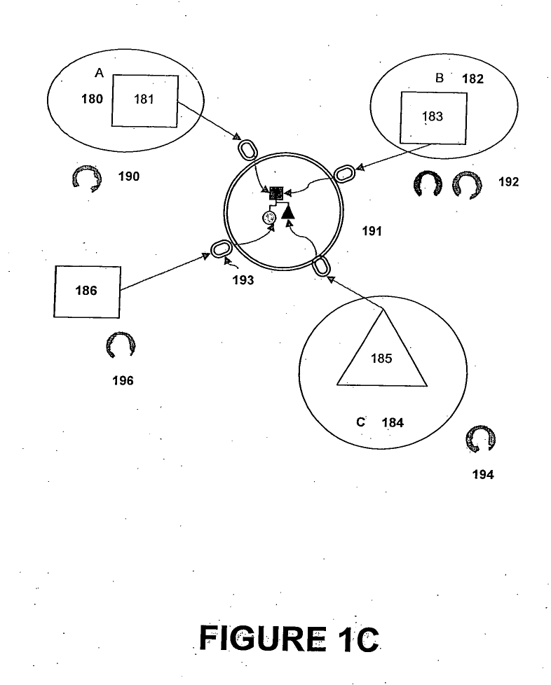

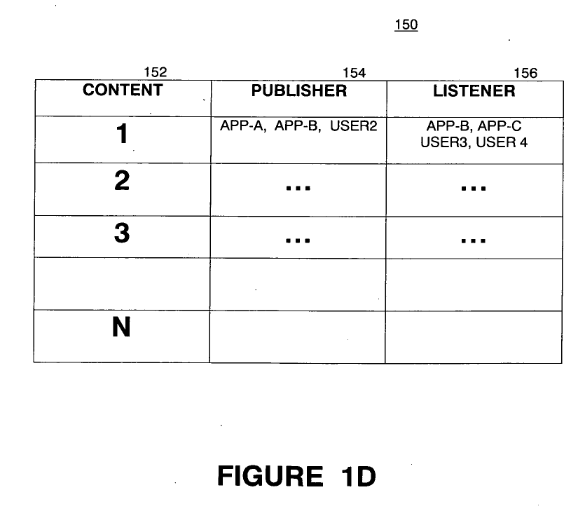

Aspects of the one or more embodiments described herein may be implemented on one or more computers executing software instructions. The computers may be networked in a client-server arrangement or similar distributed computer network. FIG. 1A illustrates a computer network system 100 that implements one or more embodiments. In system 100, a network server computer 104 is coupled, directly or indirectly, to one or more network client computers or computing devices 102, 103 and 118 through a network 110. The network interface between server computer 104 and client computer 102 may include one or more routers that serve to buffer and route the data transmitted between the server and client computers, and network 110 may be the Internet, a Wide Area Network (WAN), a Local Area Network (LAN), or any combination thereof.

In one embodiment, the server computer 104 includes an optional World-Wide Web (WWW) server 116 or server clustering environment that stores data in the form of web pages and transmits these pages as Hypertext Markup Language (HTML) files over the Internet 110 to the client computers. For this embodiment, the client computers typically run a web browser program, such as 114 to access the web pages served by server computer 116 and any available content provider or supplemental server 113.

The network client computers are configured to run a business application program, or to run as or as a dummy client which only has, for example, a web browser available. As shown in FIG. 1A, client 102 runs business application A, 105, and client 103 runs business application B, 107. The business applications can be standalone programs executed locally on the respective client computer, or they can be portions of a distributed client application run on the client or a network of client computers.

Another class of client computers is represented by mobile client 118. Mobile client 118 can be a mobile computing or communication device, such as a notebook computer, personal digital assistant (PDA), mobile phone, game console, or any similar class of mobile computing device with sufficient processing and communication capability. The mobile client 118 generally does not execute server like business applications, but may access the server computers over the network 110. For example, the mobile client may be operated by a user who has temporary access to resources on the server computers through Internet or similar network access.

In one embodiment, server 104 in network system 100 is a server computer that executes a server-side content driven routing process 112. In one embodiment, the content driven routing process can be part of an application integration system and collaboration hub platform that integrates application programs together, or it can be a standalone process executed on network server 104. The content driven routing process includes certain functional components that perform the tasks of integrating different application programs used in the project, defining the parameters related to the applications and users, and providing the hooks to route the content and processes among the applications. For the embodiment illustrated in FIG. 1, the content driven routing process includes a profile registry component 122 and a checkpoint analyzer component 124. The profile registry component 122 stores parameters for users or applications who register their profiles, which can include application location, application type and so on against the commonly shared business content. The checkpoint analyzer 124 checks the impacted users or applications on the registry list when a request is sent in from end users or applications to modify a business content object. It applies current rules and uses any relevant process status information to produce the streamlined action or event list for any impacted users or applications.

The content driven routing process 112 may represent one or more executable programs modules that are stored within network server 104 and executed locally within the server. Alternatively, process 112 may be stored on a remote storage or processing device coupled to server 104 or network 110 and accessed by server 104 to be locally executed. In a further alternative embodiment, the content driven routing process 112 may be implemented in a plurality of different program modules, each of which may be executed by two or more distributed server computers coupled to each other, or to network 110 separately.

For an embodiment in which network 110 is the Internet, network server 104 executes an optional web server process 116 to provide HTML documents, typically in the form of web pages, to client computers coupled to the network. To access the HTML files provided by server 104, client computer 102 executes a web browser process 114 that accesses web pages available on server 104 and resources, such as supplemental server 113. The client computers may access the Internet 110 through an Internet Service Provider (ISP). Content for any of the applications contained within or associated with a business application used by the client computer 102 may be provided by a data store 120 closely or loosely coupled to any of the server 104 and/or each client computer. In one embodiment, only the business content data or references to the content that is commonly shared among the applications and end users are stored at content store 120. In addition, each application may have its own database storage at the client side, and some of this data might not be of interest to other applications and users. A separate content provider 113 may provide some of the data that is included in any business application generated, transmitted, or executed over system 100. Although data store 120 is shown coupled to the network server 104, it should be noted that content data may be stored in one or more data stores coupled to any of the computers of the network, such as network client 102 or to devices within the network 110 itself.

In one embodiment, the users of each client computer 102 and 103 execute one or more business applications 105 and 107 that may be used as part of an overall business or project. For purposes of the following discussion the terms “overall business” or “project” refer to an endeavor that involves a number of different users operating a number of different computers that may execute different business application programs, and the terms “business application,” “application program,” and “enterprise application” all refer to an application program 105 or 107 that is executed on the client computer. In general, a business application is a computer program that may itself involve a number of different users, each of whom may be involved in one or more particular aspects of a business process. The business application, also referred to as an “enterprise application” involves the execution of a number of different task or processes involving the users. The business application typically also involves the creation, modification, storage and use of a number of different business content data used by the application. The overall project may involve the use of several different applications operated by different teams who perform different tasks and contribute to separate aspects of the project.

In one embodiment, the content driven routing process 112 uses specific information pertaining to the users of the system, the process flows of the overall project (referred to as “checkpoint” flows), and the shared business content used among all involved applications and/or users to automate and combine certain aspects of all of the application programs used in the overall business or project, such as the content management and user collaboration aspects of the application. In general, this is accomplished by defining the overall project workflow as a process lifecycle consisting of numerous checkpoints through which the business content transitions. Modification of the business content at each checkpoint is controlled by a versioning mechanism that incorporates role based access controls associated with the various users of the system, and to route the proper actions/events to the appropriate application at the right time. In general all applications generate and/or act on their own or common content within the system. Some content may be restricted to a particular user or application and not intended to be shared. Other content may be accessed by other users or applications within the system. This content is referred to as the “shared content,” and generally refers to the content routed and processed by the content driven routing process 112.

The overall business project implemented by system 100 typically embodies many different users, applications, processes and business content, all interacting with one another over a distributed computer network. FIG. 1B illustrates the interactivity among a plurality of business applications and entities, according to an embodiment. As shown in FIG. 1B, a number of different business applications denoted business application A through business application E are operated by one or more users (teams), each performing their own task. Each application corresponds to a business application executed on a client computer, such as client 102 or 103 of FIG. 1A. In one embodiment, the application integration aspect of the content driven routing process 112, integrates the process flows, business data, user privileges, and even external team relationships so that the individual applications are integrated as part of an entire project, rather than a combination of separate applications. Each application also generates, stores, and maintains its business content in its own respective content store, e.g., data store 170. The interactivity provided by the content driven routing process 112 allows user teams 160 to 166 from the different applications to communicate with teams from other applications through the business process flows and/or the business content used by their respective application programs. Thus, as shown by the example cross work team communication of FIG. 1B, application A can interact directly with application B, application B can interact with application E, and application C can interact with application D, and so on. Any degree of interactivity among and between the different applications, as well as between the applications and any external entities can vary depending upon the actual requirements and constraints of the overall business project.

The applications illustrated in FIG. 1B can be any type of program that performs a task within the interactive work team, such as finance, design, media production, enterprise resource planning, inventory, interactive video streaming, and any other type of program. The application integration aspect of the content driven routing process essentially converts the individual silo applications to virtual business applications that are leveraged to provide cross-team features. At run-time, the applications are practically merged to form interacting components of the overall project with collaboration among the different teams and true sharing of the common business content data.

FIG. 1C illustrates the processing of business content in a content driven routing platform, according to an embodiment. Business content generally refers to any content that is created, modified, or otherwise used by the applications comprising the overall project. It should be noted that the term “content” can refer to any real or virtual collection of business data, objects or information used by the system. Such business content may be organized as files, documents, databases, pages, lists, or similar objects, and could include many different types of data, such as text, graphics, sound, video, and the like. The example of FIG. 1C shows four teams of users 190, 192, 194, and 196. User 190 operates business application A, 180, which has shared content 181; team 192 operates business application B, 182, which has shared content 183, and user 194 operates business application C, 184, which has shared content 185. User 196 does not run an application, but manages content 186, which may or may not be from a business application used in the project. The content for any of the applications can originate from multiple sources, or it can originate from a single source. Thus, content 181 used by application A could originate from application A or B, while content 185 used by application C could originate only from application C.

FIG. 1C illustrates the collaboration platform and routing process that links the users, applications, and shared business content together. The server 104, web server process 116, data store 120, and content driven routing process 112 of FIG. 1A are represented as functional hub (or “collaboration hub”) unit 191 of FIG. 1C. Each user, application and/or content data interfaces with the collaboration hub 191 through individual interface links or “registry gates” 193. The content data from each application is stored by the content driven routing process in one or more data stores, such as storage memory 120 in FIG. 1A.

The basic processing performed on the data by the content driven routing process 112 includes establishing the links between the applications and users based on the content from each respective application. Once stored in the collaboration hub platform 191, the content can be considered to be represented by a three-dimensional parameter model. The shared content for each application contains a regular object description (first dimension), a rich object field matrix (second dimension), and a distributed checkpoint model to manage the content being accessed and controlled by the multiple teams and applications over a time period. The rich object field matrix links the content to the application or applications that use it. Thus, in general, the shared content is selected and abstracted from the original (silo) application, and stored in the collaboration hub with the three dimensions of descriptive parameters. The data is then leveraged by the program components of content driven routing process to establish the linkages within the overall project, the checkpoints defined by the application steps, the user role based access control (RBAC) definitions, and so on. In general, the collaboration hub 191 stores the information related to the content, process, and users for each application of the project, and the content driven routing process integrates this information to derive the necessary linkages to create a virtually seamless unified enterprise application from the separate business applications. This overall linkage and routing process are controlled by the profile registry 122 and checkpoint analyzer 124 functions of the routing process 112.

Different applications can impact the same set or type of data constituting the shared content, even though this content may be treated differently by each application. For example, with reference to FIG. 1C, application A, 180 and application B, 182 may both use the same business content (e.g., a customer list) within the system. These applications may be the same or they may be different, in which case the customer list information stored on the hub may be an integrated or composite data object that is managed by the two different applications. Thus, the content objects stored on the hub 191 may come from two or more different sources. To maintain the integrity of the shared content, the applications must synchronize their activities with regard to the shared content. In one embodiment, the two or more applications that share a particular content object communicate with one another through an application message bus. An application or user that generates or modifies shared content is referred to as a “publisher.” A publisher transmits a notification to the one or more other applications or users, referred to as “listeners,” that share the content.

In one embodiment, the relationship among the publishers and listeners for particular units or objects of shared content is maintained in a database or table by the content driven routing process. This database correlates the users and/or applications that constitute the publishers and those that constitute the listeners for each shared content object. FIG. 1D illustrates an example of an application bus matrix, under an embodiment. As shown in FIG. 1D, the matrix consists of columns 152 to 156 for the 1 to N shared content objects and their corresponding publishers 154 and listeners 156. In the example of matrix 150, for content object 1, the publishers are Application A, Application B, and User 2, and the listeners are Application B, Application C, and Users 3 and 4. All other content objects 2-N would have similar entries in their respective publisher and listener table cells.

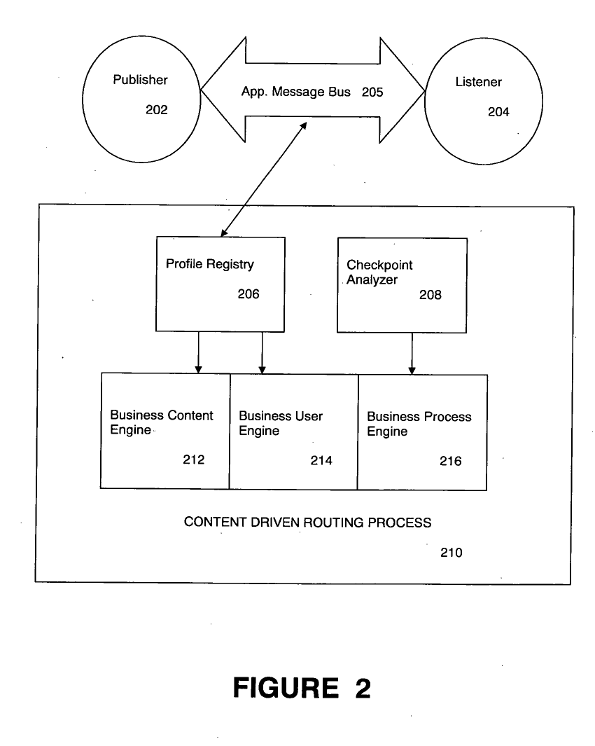

FIG. 2 illustrates the interface between the application message bus and the content driven routing process, according to an embodiment. As shown in FIG. 2, a publisher 202 and listener 204 communicate through application message bus 205. When publisher 202 modifies the shared content, it notifies all of the listeners 204 over this bus. The application message bus 205 transmits the notification information, and not the changed content itself. The content driven routing process 210 controls the processing of the shared data. In one embodiment, the content driven routing process 210 includes a number of different programs (also referred to as “engines”) to process the notifications transmitted on the application message bus 205. FIG. 2 shows the main components of the content driven routing process, according to an embodiment. The main component programs of the content driven routing process 210 include: a business content engine 212, a business user engine 214, and a business process engine 216.

As illustrated in FIG. 2, the business content engine 212 and the business user engine 214 are used by the profile registry 206, and the business process engine 216 is used by the checkpoint analyzer 208 to process the shared content modifications performed by the publisher 202. The profile registry 206 resides functionally on top of the engines to facilitate the processing of the shared content with respect to the registered application and user information. The checkpoint analyzer 208 facilitates the data, user and process linkage, so that the input and output to and from the publishers and listeners follow certain business processes and rules. In this manner, a user or application will be virtually integrated within the process on an on-demand basis.

In one embodiment, the business content engine 212 is a programming module that imports, stores and conditions the business content for runtime execution by the content driven routing process. It prepares the hooks that provide the content linkage from the different applications, and hands over the rich content data structures to the other engines of the routing process 210.

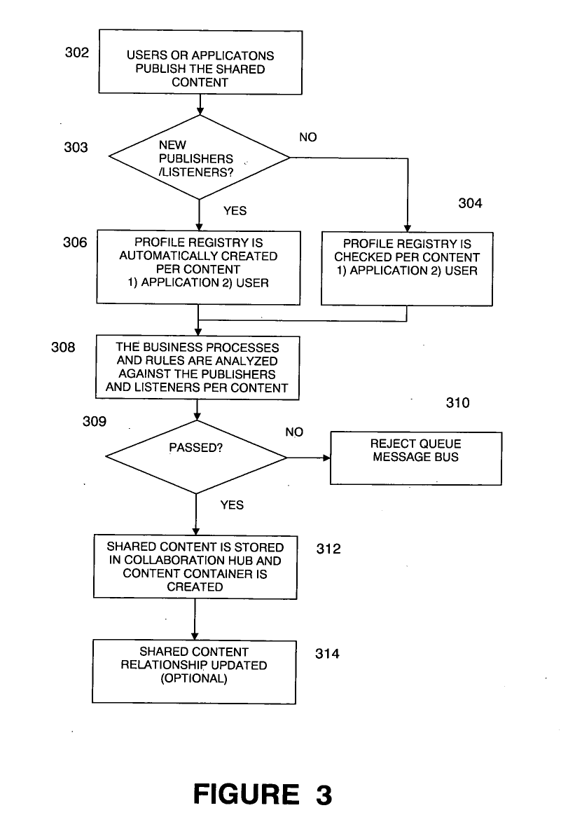

FIG. 3 is a flowchart that illustrates general processing steps associated with the storage and modification of content through the content driven routing process, according to an embodiment. The users or applications publish the shared content, 302. In step 303, it is determined whether the user or application in step 302 is a new publisher or listener. If it is new, a profile registry 206 is automatically created for that application and/or user on the basis of the content, step 306. If, in step 303, it is determined that the publisher/listener is not new, then a profile registry should already exist, in which case it is checked, step 304. The business processes and rules are then analyzed against the publishers and listeners on the basis of the shared content, step 308. If the content does not pass the processes and rules, it is placed on a reject queue message bus. If the content does pass, as determined in 309, the content driven routing process tags it with markers (or “hooks”) and creates a content container for it, step 312. In one embodiment, the hooks include various version and source identifiers that facilitate dynamic process trigger points used by the other processing engines of content driven routing process during project definition and runtime execution. Once the content is stored in 312, the users can define the relationships for the shared content, step 314.

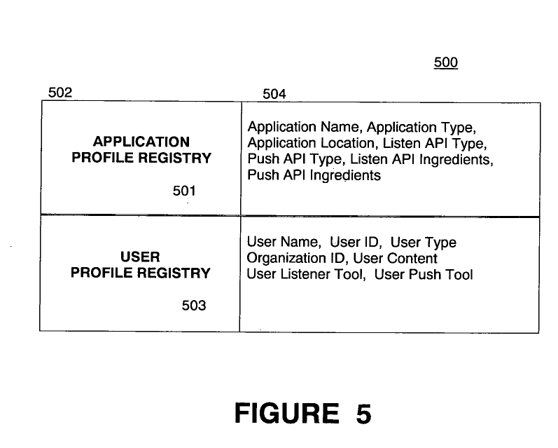

In one embodiment, the profile registry comprises an application profile registry and a user profile registry. FIG. 5 illustrates the elements of the profile registry, under an embodiment. As shown in Table 500, the application profile registry 501 contains descriptors that specify the application. These include the application name, type, and location. Other descriptors include the listen API type, push API type, and the listen and push API ingredients. The user profile registry 503 contains descriptors that specify the user. These include the user name, user ID, and user type. Other user descriptors include the organization ID, user content, and the user listener and push tools. The profile registry 500 is a logical component that specifies, through the descriptors, who is the original owner or interested parties (user or application) of the shared content. This information is used to notify the interested parties in the event of an update or creation of the shared data. The profile registry keeps track of which application uses the content and which user owns the content. The profile registry is invoked each time a user or application enters the collaboration hub. Thus, as conceptually shown in FIG. 1C when a user or application enters hub 191 through interface or registry gate 193, the profile registry for that user or application is checked. The first time that a user or application interacts with the hub, a profile registry is created for that user or application. All subsequent accesses for that user or application will then utilize the created profile registry, as shown in steps 304 and 306 of FIG. 3.

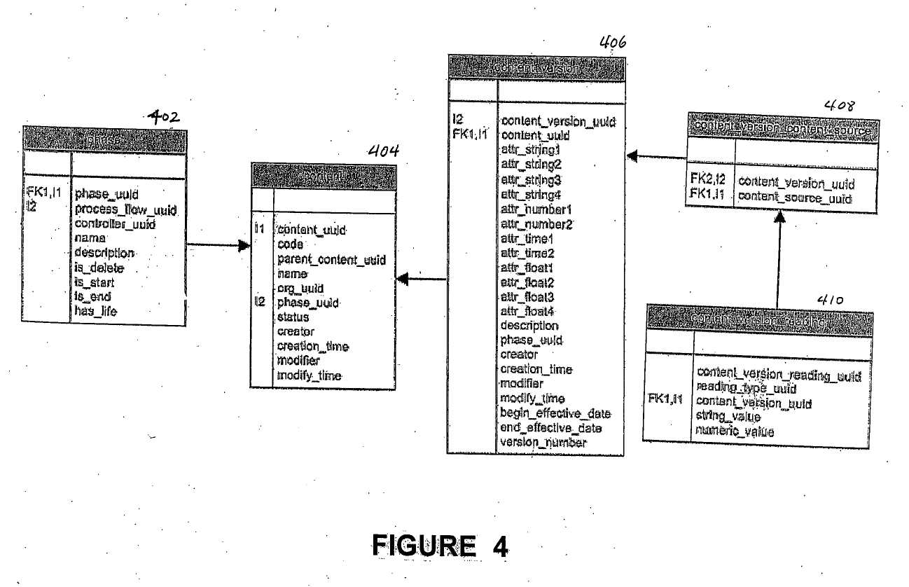

As described above with respect to FIG. 3, once the shared content is imported into the collaboration hub, it is tagged with various identifier hooks. FIG. 4 illustrates the tagging of business content with identifier hooks, under an embodiment. Each block of FIG. 4 illustrates a process object corresponding to a function performed by the content engine 202. The left column of each block illustrates an example internal table ID or container ID, while the right column contains the descriptors for the parameters manipulated by that function block. For the diagram illustrated in FIG. 4, the phase block 402 defines the phase or stage (age) of the content itself. As shown in FIG. 4, content can be in a phase corresponding to a start point or an end point, or an in-life point. The phase 402 can also specify the stage of the process or project in which the data is used, and corresponds to the checkpoints that are contained in the workflow of the project. Once the content itself is defined, the phase of the content is defined, 404. The content can also be tagged with various types of identifiers, such as name, parent or child identifiers, status, creator, creation time, modification history, and so on. In most practical applications, content is modified by processes or users within the application. Thus, the content 404 is also tagged with explicit content version information 406. The version component 406 creates a version number associated with the content and stores critical version information such as modification time, modification source, and duration (statt/end time) for the version. The content version object 406 itself is conditioned by a content source 408 object, which describes the sources of the content, and a content version reading component 410, which provides the access filters.

As illustrated in FIG. 2, the content driven routing process includes a number of processing components or engines that work on the shared content and the application message bus through the functional profile registry 206 and checkpoint analyzer 208 components. The business user engine 214 is a programming module that defines and stores the identity, hierarchy, and privileges of the various users of the content data defined and stored by the business content engine 212. The users processed by the business user engine may be any person, entity, or application that creates, modifies, views, or otherwise impacts the business content within the system. In most practical applications, any number of users may be allowed to access and/or modify the business content. The business user engine enforces the hierarchical and privilege rules associated with or assigned to the users of the system. Typically each user who accesses or “touches” the content through the course of the project is assigned a privilege or a role. This role will govern the privileges with regard to who can create, view, modify or destroy any shared content object. The role assigned to each user is also utilized in the checkpoint flow defined for the application. The checkpoint flow defines which users or applications are required to touch a particular business content at a given period of the project lifecycle. The role/privileges of a user or application may be different with respect to the same content over time, depending on the content stage in the checkpoint flow.

Users and/or applications may be associated with different business content created and defined by the system. Each element of business content defined for the multiple applications and the users of that content comprise a “hub” (such as the collaboration hub 191 illustrated in FIG. 1C). A distributed collaborative environment may comprise a number of different hubs, each with its own business content and group of user and applications, as well as project scope. A user or application within the system may be associated with two or more hubs. That user's privilege may be the same or different for both hubs.

The business process engine 216 controls the series of critical checkpoints of business content within the content driven routing process 210. The application integration aspect of this process uses the concept of “checkpoints” to mark significant milestones or transition points during the lifecycle of the business content. The business process engine 216 is a content sensitive module that provides dynamic checkpoint control over any item or unit of business content. As business content is processed by the system, it undergoes modification or validation through the use of checkpoints defined by the business process engine. This engine defines and maintains one or more checkpoints, at which the business content undergoes a transition or modification. The transition or modification can be effected by one or more users of the system and/or one or more applications of the system. The transition or modification at each checkpoint can be an act that modifies the business content in some way, validates the content, routes the content within the system, or any other processing step or combination of processing steps that impacts the business content.

In one embodiment, each checkpoint includes a gate or phase control point, a user hook, a content hook, and a transit locking mechanism. The business process engine is configured to learn or define the lifecycle checkpoints of the business content, and create the metadata space for the business content phase hook for each of the content lifecycle checkpoints. The checkpoints can also include any business rule that triggers the automation of the business processes. In general, a business rule is a rule that modifies, validates, routes or otherwise processes the business content depending upon one or more variables or conditions. In one embodiment, the checkpoint analyzer 208 learns the business rules, which define which user or application can do what act and when, the content, the checkpoints, and the derived processes. Rules are translated into event rules and locking rules and passed on to both an event engine and locking engine within the content driven routing process. These rules are also converted into passive read-only and interactive read/write action event components for involved silo applications, and interactive read/write graphical components for display to the end users.

The lifecycle of the process essentially comprises the timeline of the application and includes the one or more checkpoints. The lifecycle can include one or more sub processes or sub-lifecycles, each of which has its own set of checkpoints. Thus, the checkpoint flow of a content comprises one or more sub-checkpoint flows recursively. Each sub checkpoint node (leaf node) consists of the combination of processes and business rules.

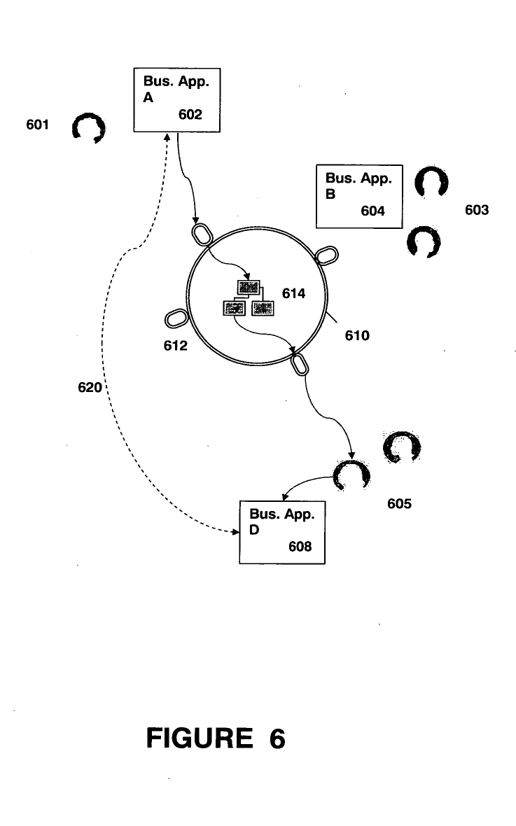

The content driven routing process facilitates the routing of application processes and user communication on the basis of the business content. The routing process establishes peer-to-peer connections or communication links on demand between users and or business applications based on the business content utilized by their respective sources. FIG. 6 illustrates the creation of content-based transmission routes among users and/or silo applications, according to an embodiment. For the example shown in FIG. 6, a number of business applications operated by respective teams of users are integrated through a collaboration hub platform 610. Business application A, 602 is operated by user 601, business application B, 604 is operated by team 603, and business application D, 608 is operated by team 605. Each application has its own registry gate 612 to the collaboration hub 610. Upon interfacing with the hub, the profile registry for that application is checked, or created if it is the first interface instance for the application.

For the embodiment illustrated in FIG. 2, the business content engine 212 and the business user engine 214 define the profile registry for the users and applications, as well as the application message bus matrix for the shared content utilized by the applications and users integrated through the hub 61 0. These components are stored in the hub, such as in data store 120 by the content driven routing process and provide the necessary information pertaining to the users of the content, the processes that create, modify, destroy or otherwise use the shared content. When a request is sent in from a users or application to modify a business content object, the checkpoint analyzer 208 checks the impacted parties on the profile registry list based on the current rules and process status to produce the streamlined action or event list for impacted parties. The action component, rather than the content itself, is routed to the impacted users or applications on demand for smooth collaboration and integration.

Thus, as shown in FIG. 6, user 601 or application A is illustrated as modifying a business content object that relates to another business content object (or the same content) that user 605 or application D has registered interest in as well. This would be specified in the application message bus matrix, such as shown in FIG. 1D. Based on the matrix and checkpoint analyzer processes, the relative action components will be sent to the proper users and applications, such as user 605 or application D. After this “match” and “hand-shaking” process, application A 602 establishes a virtual direct route 620 to integrate with application D. This illustrates an instance of on-demand content based routing established by the profile registry, application message bus matrix and checkpoint analyzer process.

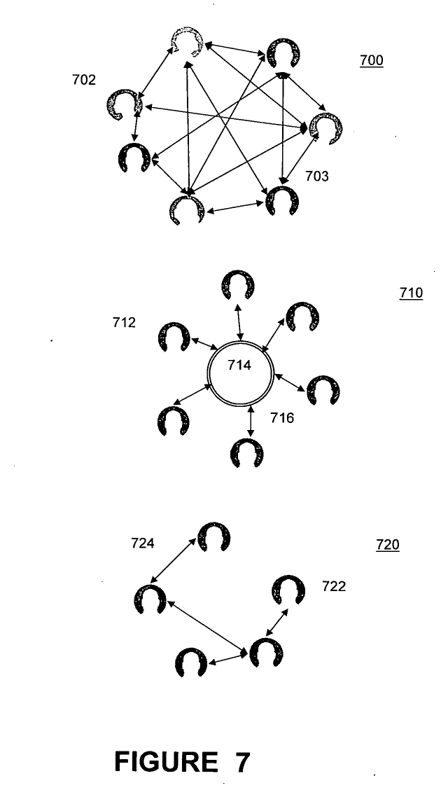

The content based routing process described above creates a functional remapping of the overall business project network by defining an intermediate “hub and spoke” interface model between the collaboration hub and the individual users and applications, and then builds the virtual direct links on demand between the users and applications based on the content and the current checkpoint process/rules of the content. FIG. 7 illustrates the development of content-based routes from mesh-based business application integration through hub-and-spoke links to direct links, according to an embodiment. As shown in FIG. 7, the original project network 700 prior to application integration may consist of many network links 703 between all users or applications 702 for the system. The project might require a full meshed-point-to-point business application integration in the worst-case scenario, and a situation in which every user or application must be allowed to communicate with every other user or application, thus the network mesh comprising all possible links 703 can be very complicated. Moreover, under present systems, the integration can not be dynamic (on-demand) so the data is often out of synch, thus making the overall project error-prone and insecure. The content driven routing process 112 that allows the creation of a common content model and unified integration of application processes and user definitions provides a central collaboration hub 714, which acts as a central network point for the applications and users 712. Instead of many links 703 to every other user in the system, the collaboration hub allows a great reduction in the number of communication links to virtually a single link 716 from each application or user to the hub 714. At application runtime, the content-based routing process allows a further reduction of links to just those necessary within the process step being executed. In FIG. 7, view 710 represents the collaboration hub design view in which all pertinent content and user/application information is stored at hub through content engine, profile registry, and checkpoint analyzer; and view 720 represents the creation of the virtual direct links for the integrated users/applications for each shared content object.

The establishment of virtual direct individual peer-to-peer communication links from the hub-and-spoke scheme of the collaboration hub is further illustrated in FIG. 6. As shown in FIG. 6, the routing process establishes a virtual direct peer-to-peer link on demand between business application A, 602 and business application D, 608 through link 620. The peer-to-peer link that is established by the content-based routing process can be a user to user link, a user to content link, a user to business application link, a content to business application link, a business application to business application link, or any other permutation thereof. The applications can be local user applications (such as client-side applications). The users and teams could be standalone entities or they could be part of larger or separate networks that are tied in to the other entities of the system by collaboration hub 610.

In one embodiment, the content driven routing process may be provided as a service that can be used by all involved cross teams without the need for the user to install or maintain any software on the user's computer or network. The content driven routing process is scalable so that the user can define any scope of the business project desired, from a single project to an entire integrated enterprise system involving many distributed processes integration and data synchronizations.

Embodiments of the content driven routing process described herein may be applied to various types of computer applications, enterprise applications, and communications software such as mail, message or content delivery methods utilizing communication over the Internet or similar distributed network. It may be implemented as software or as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the application integration method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the content-based routing process is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the application integration and content-based routing system and process in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the content-based routing process are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of routing application processes in a distributed network executing a plurality of integrated application programs, the method comprising:
defining a network of the plurality of users operating a plurality of different applications, wherein any user can communicate with any other user within the distributed network;
defining shared content created by an application of the plurality of applications and capable of being processed by at least one or more other applications of the plurality of applications, wherein the shared business content is used by one or more of the plurality of applications, and wherein each application comprises a series of checkpoint steps;
routing process steps of the one or more applications within the distributed network as required, on the basis of one or more characteristics of the shared content and one or more characteristics of the plurality of users.

2. The method of claim 1, wherein each user performs at least one of the tasks of creating, modifying, approving and destroying the shared business content.

3. The method of claim 1, wherein the shared business content comprises one or more discrete data objects representing an aspect of the shared content.

4. The method of claim 3, wherein the information regarding the one or more applications and the plurality of users is stored in a profile registry.

5. The method of claim 4, wherein the profile registry includes a descriptor tags describing one or more user profiles, and the one or more applications that use the shared content.

6. The method of claim 5, wherein each application is an application program executed on a first client computer operated by a first user or application accessible to a second user through a second client computer.

7. The method of claim 5 further comprising a checkpoint analyzer that analyzes a business rule or process applied to the shared content.

8. The method of claim 7 wherein the process steps of the application with regard to the shared content are routed within the network based on the rule or process applied to the shared content data and the profile registry information.

9. The method of claim 6, wherein the shared business content is stored in a data store connected to a server computer coupled to the first client computer and the second client computer.

10. The method of claim 9 wherein the user profile specifies the user's access privileges with respect to the shared content.

11. A method comprising:
receiving a request from one or more publishers to modify a shared content object;
checking publisher characteristics against a profile registry;
transmitting processing steps representing actions to modify the shared content object to one or more listeners that use the shared content data;
checking characteristics of the listeners against the profile registry based on a set of current rules and process status to affect the modification on the shared content data; and
storing the shared content data in a data store accessible to the one or more publishers and the one or more listeners.

12. The method of claim 11 wherein each publisher of the one or more publishers is an application program or a user of the shared content.

13. The method of claim 12 wherein the profile registry comprises:
an application profile registry storing application name, application type, application location and application interface information for an application publisher; and
a user profile registry storing user name, user type, and user organization information for a user publisher.

14. The method of claim 12 wherein the one or more listeners are each an application program or a user of the shared content.

15. The method of claim 14 wherein the profile registry comprises:
an application profile registry storing application name, application type, application location and application interface information for an application listener; and
a user profile registry storing user name, user type, and user organization information for a user listener.

16. The method of claim 11 wherein the one or more publishers and the one or more listeners communication over an application message bus.

17. A system comprising:
means for receiving a request from one or more publishers to modify a shared content object;
means for checking publisher characteristics against a profile registry;
transmission means for transmitting processing steps representing actions to modify the shared content object to one or more listeners that use the shared content data;
means for checking characteristics of the listeners against the profile registry based on a set of current rules and process status to affect the modification on the shared content data; and
storage means for storing the shared content data in a data store accessible to the one or more publishers and the one or more listeners.

18. The system of claim 17 wherein the storage means comprises an application message bus coupling the one or more publishers to the one or more listeners.

19. The system of claim 18 wherein the one or more publishers and the one or more listeners are each an application program or user of the shared content.

20. The system of claim 19 wherein the profile registry comprises:
an application profile registry storing application name, application type, application location and application interface information for an application publisher and application listener; and
a user profile registry storing user name, user type, and user organization information for a user publisher and user listener.
